(19) United States
(12) Patent Application Publication
(10) Pub. No.: US 2005/0172219 A1
(43) Pub. Date: Aug. 4, 2005

(54) Multi-image file apparatus and method

(75) Inventors: Gregory Richard Hintermeister, Rochester, MN (US); Michael D. Rahn, Rochester, MN (US)

Correspondence Address: Grant A. Johnson;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/767,044

(22) Filed: Jan. 29, 2004

(51) Int. Cl. G06F 17/00

(52) U.S. Cl. 715/513; 715/500.1

(57) ABSTRACT

The present invention provides a method, system, and article of manufacture that provides an easier, more robust, and more flexible way to maintain dynamic network content. One aspect of the present invention is a method of displaying a web page. One embodiment of the method comprises receiving a multi-image file, the multi-image file comprising a primary image and at least one secondary image adapted for cooperative display; receiving a web page containing a markup language tag, the markup language tag comprising a code specified which of the primary image and the secondary image should be displayed; and displaying the web page with the primary image. This embodiment may further parsing the multi-image file for an information header, the information header containing an image name for each image in the multi-image file, a primary image indicator, and an image location for each image in the multi-image file. The primary and secondary images may be alternate versions of the same images or may be designed for display in a cooperative manner.

### TECHNICAL FIELD

This invention generally relates to methods and apparatuses for displaying, creating, and manipulating graphical images. More specifically, the present invention relates to a method and apparatus for creating, displaying, and manipulating a multi-image file.

### BACKGROUND

The latter half of the twentieth century has been witness to a phenomenon known as the information revolution. While the information revolution is a historical development broader in scope than any one event or machine, one of its hallmarks has been the explosive growth of the Internet, particularly the World Wide Web (“Web”).

The Web generally comprises a system of interconnected computers called web servers that collectively contain billions of individual documents called web pages. These web pages are typically formatted according to a special language called Hypertext Markup Language (“HTML”) that supports “hyperlinks” to other HTML-formatted web pages, as well as to other types of graphics, audio, and video files. Special computer programs called web browsers request copies of the web pages from the web servers and then render the HTML script for the user. Commonly used web browsers include the Netscape Navigator browser, the Microsoft Internet Explorer browser, and the Mozilla project's Mozilla browser.

Many web developers produce a number of related web pages, collectively called a web site, that are designed to present a large amount of information in a user friendly way. One common technique used by Web site developers to help the end user find information more quickly is to create a graphical navigation interface. The most common type of graphical navigation interface is a menu pane. Typically, menu panes contain a number of graphical elements representing potential choices. Each graphical element consists of a separate image, usually encoded according to the Graphical Interchange Format (“GIF”) standard or the Joint Photographic Experts Group (“JPEG” or “JPG”) standard. Although GIF and JPEG require a relatively small amount of space to store the image, a typical menu requires dozens of individual graphical elements. The shear volume of these images creates many problems. For example, tracking, maintaining, and naming of many small files can impose significant administrative burdens on the web site developer. The volume of images also increases the number of server connections and network traffic because each individual file must be downloaded from the web server computer.

Many Web site developers try to further improve usability by making their graphical navigation interfaces dynamic. One common technique used to generate a dynamic graphical navigation interfaces uses multiple versions of each graphical element, with each version having small variations in color and/or shape. These images can be linked together with scripting engines to produce a controlled animation effect called a ‘rollover.’ FIGS. 8a-8c show a web site 800 using this technique. This product website 800 has five menu choices 810-818. Generating a rollover state and a graphical submenu for the first menu choice 810 requires three separate image files: (i) one image 802 showing the initial shaded menu item, (ii) a second image 806 for display when the end user passes the mouse curser 808 over the menu choice 810; and (iii) a third image 808 to show the product submenu items. If the other menu choices 812-818 have similar dynamic effects, this simple dynamic graphical navigation interface will require fifteen separate image files. Those skilled in the art will appreciate that complex sites can require servers hundreds or even thousands of small image files, every one of which must be created, tracked, maintained, and transmitted to the browser.

Without a way to easily create and maintain dynamic network content, the promise of the Internet may never be fully achieved.

### SUMMARY

The present invention provides a method, system, and article of manufacture that provides an easier, more robust, and more flexible way to maintain dynamic network content. One aspect of the present invention is a method of displaying a web page. One embodiment of the method comprises receiving a multi-image file, the multi-image file comprising a primary image and at least one secondary image adapted for cooperative display; receiving a web page containing a markup language tag, the markup language tag comprising a code specified which of the primary image and the secondary image should be displayed; and displaying the web page with the primary image. This embodiment may further parsing the multi-image file for an information header, the information header containing an image name for each image in the multi-image file, a primary image indicator, and an image location for each image in the multi-image file.

Another aspect of the present invention is a web page comprising a multi-image file, the multi-image file comprising a primary image and at least one secondary image adapted for cooperative display; and a markup language tag, the markup language tag comprising a code specified which of the primary image and the secondary image should be displayed. In some embodiments, the multi-image file further comprises an image descriptor associated with the primary image and an image descriptor associated with the at least one secondary image. The image descriptors in these embodiments each comprise an image name, a primary image indicator, and a default size.

Yet another aspect of the present invention is a method of displaying images. One embodiment of this method comprises receiving a multi-image file, the multi-image file comprising a primary image and at least one secondary image, selecting an image for display from the multi-image file, and displaying the selected image. This method may be embodied on a signal bearing media to form a computer program product.

### BRIEF DESCRIPTION OF THE DRAWINGS

FIG. 1 depicts an information technology system embodiment.

FIG. 2 conceptually depicts a multi-image file embodiment.

FIGS. 3a and 3b depict a multi-image file in operation.

FIGS. 4-7 depict methods of processing a web page having multi-image files.

FIGS. 8a-8c (prior art) depict a conventional product website having two rollover states.

### DETAILED DESCRIPTION

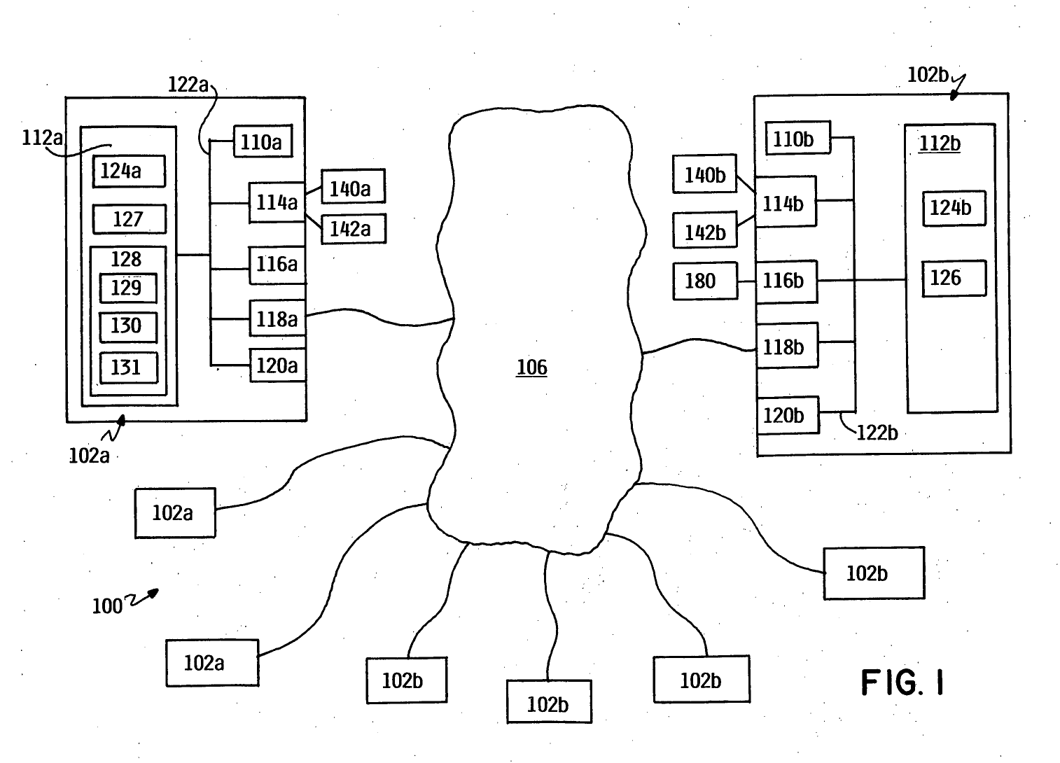

FIG. 1 shows one embodiment an information technology system 100 comprising a plurality of web server computer systems 102a and a plurality of client computer systems 102b (only one web server 102a and client computer 102b shown in detail for clarity) interconnected by a communications medium 106. Each computer system 102 has one or more central processing units 110 (“CPU”) connected to a main memory unit 112, a mass storage interface 114, a display interface 116, a network interface 118, and an input/output (“I/O”) interface 120 by a system bus 122. The mass storage interfaces 114 connect the system busses 122 to one or more mass storage devices, such as a direct access storage device 140 and a readable and a writable optical disk drive 142. The network interfaces 118 allow the computer systems 102 to communicate with each other over the communications medium 106. The main memory 112a in the web server computers 102a contains an operating system 124a, and a web server application 127 capable of servicing requests for web pages 128 containing a mix of conventional image files 129, multi-image files 130, and textual information 131. The main memory 112b in the client computer systems 102b contains an operating system 124b and a web browser 126 capable of requesting the web pages 128 from the web server computer 102a, rendering the web pages 128, and interpreting the multi-image files 130.

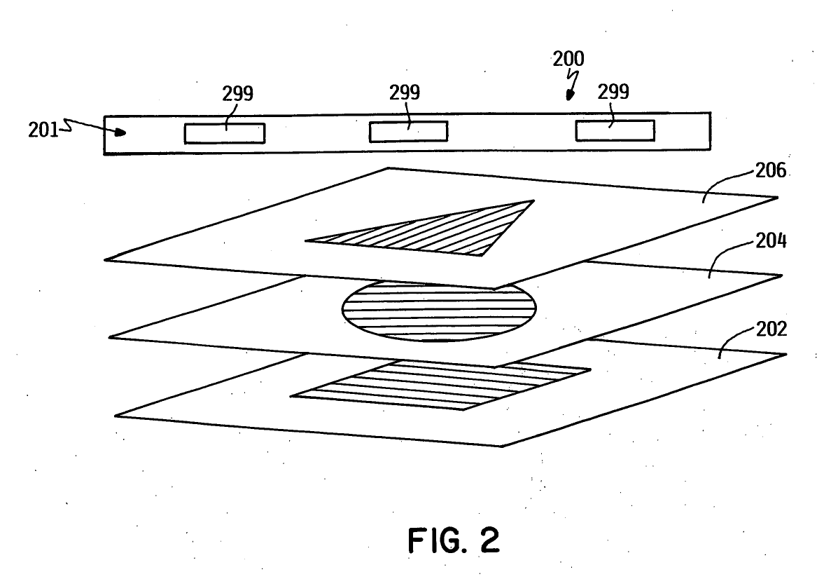

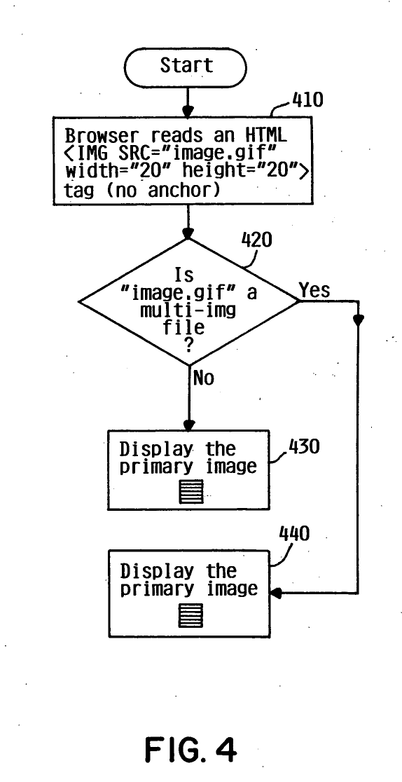

FIG. 2 conceptually depicts one embodiment of a multi-image file 200. This multi-image file 200 comprises an information header 201, a primary image 202, and one or more secondary images 204, 206. The primary image 202 is displayed by default when the web browser 126 loads the multi-image file 200 without referencing a specific image 202-206. As will be discussed in greater detail with reference to FIGS. 4-7, the secondary images 204-206 may be displayed together with the primary image 202 or another secondary image 204-206 to form a combined image, displayed individually in place of the primary image 202, or some combination thereof. That is, the primary image 202 and secondary images 204-206 may be displayed together as complementary layers, as alternative versions of the same image, or a combination of cooperative and alternative elements. The manner in which these images 202-206 are displayed will depend, in this embodiment, on an additional parameter (e.g., the image name) provided to the web browser 126. Any of the images 202-206 in this embodiment can be specified as the primary image 202.

The information header 201 in this embodiment contains an image descriptor 299 for each image in the multi-image file 200. Each image descriptor 299, in turn, contains a unique image name block comprising a sequence of sub-blocks (not shown) containing between 1 byte and 255 bytes of information. In this embodiment, one sub-block contains an identifier or name, which should be unique within that particular multi-image file 200. Another sub-block contains a one-byte flag indicating whether the associated image is the primary image or a secondary image. A third sub-block contains a memory offset from the start of the multi-image file 200 to identify the location of the associated image in the multi-image file 200. A fourth sub-block indicates the number of vertical pixels in the image and the number of horizontal pixels in the image.

The primary image 202 and the secondary images 204-206 in this embodiment may be encoded using any suitable technique for representing visual information. Suitable encoding techniques include, without limitation, GIF, JPEG, Portable Network Graphics (“PNG”), tagged image file format (“TIFF”), device-independent bitmap format (“DIB” or “BMP”), PostScript® format, .PCX format, and Xerox image file format (“XIF”) format. Embodiments using the PNG format may be particularly desirable because the encoding specification includes a transparency value. The primary image 202 and the secondary images 204-206 maybe encoded using the same technique or may use different techniques. Moreover, those skilled in the art will appreciate that FIG. 2 only illustrates the logical relationship between the images, and not their actual visual appearance in the web browser 126 or other rendering device.

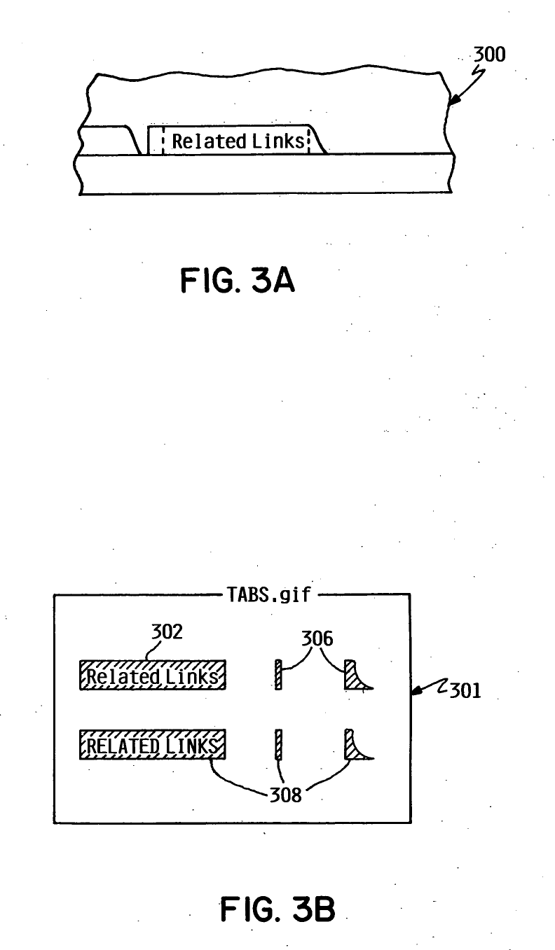

FIGS. 3a-3b illustrate an example multi-image file 301 in operation. More specifically, FIG. 3a depicts a dynamic tab control 300 generated using an appropriate scripting language, such as JavaScript, from the multi-image file 301 in FIG. 3b. In this example, the multi-image file 301 consists of a primary image 302, two secondary images 306 that are designed to work cooperatively with the primary image 302 to generate a first version of the tab control 300, and three secondary images 308 designed to replace the primary image 304 and the secondary images 306 to create a mouse-over feedback effect. That is, when a mouse cursor moves over the primary image 302 or one of the secondary images 306, the JavaScript program causes the client's web browser 126 to automatically switch to the secondary images 308. In this way, tab control 300 will appear to react to a mouse-over event. Again, those skilled in the art will appreciate that FIG. 3b only illustrates the logical relationship between the images in the multi-image file 301.

FIGS. 4-7 illustrate methods of processing web pages 128 with reference to the multi-image file 200 in FIG. 2. More specifically, FIG. 4 illustrates one method of processing a multi-image file 200 named “TABS.gif,” which contains a primary image 202. At block 410, the browser 126 receives the web page 128 from the web server 102a. The browser 126 then reads an HTML tag identifying an image and requests the associated digital information from the web server 102a. The HTML tag read by the browser 126 in this embodiment is: <IMG SRC=“TABS.gif” width=“20” height=“20”>, where the first part of the HTML tag, “TABS.gif,” identifies the multi-image file 130 called “TABS.gif;” the second part of the source attribute, “width=“20” height=“20” specifies how large an area in which the browser 126 should display the image. At block 420, the browser 126 determines whether the downloaded image is a conventional image file 129 or a multi-image file 200. One method of making this determination to parse the downloaded image file for image descriptors 299 (see FIG. 2). If the image file is a conventional image file 129, the browser 126 displays the image file using conventional techniques at block 430. If the image file is a multi-image file 200 and the HTML code did not specify an initial image, the browser 126 automatically displays the primary image 202 at block 440.

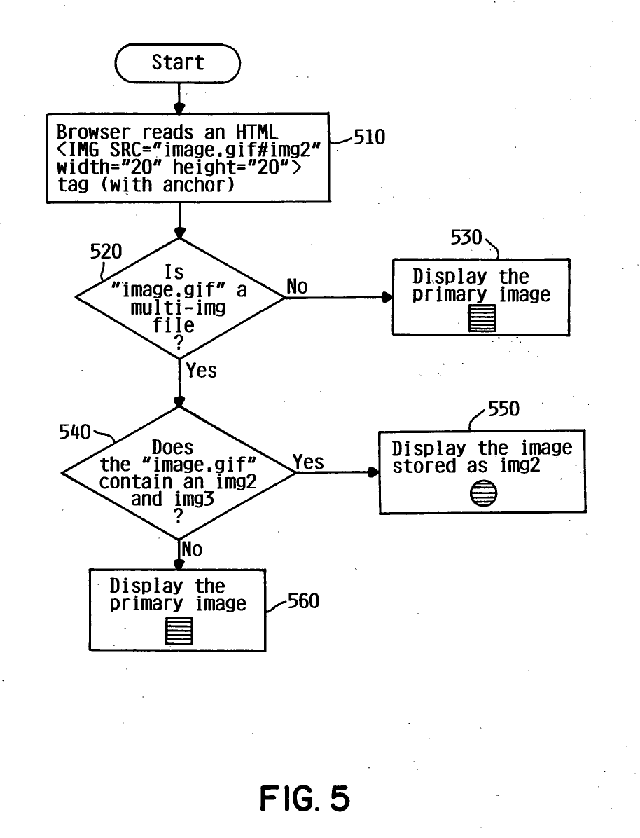

FIG. 5 illustrates one method of processing a multi-image file 200 named “TABS.gif,” which contains a primary image 202 named “img1” and a secondary image 204 named “img2.” At block 510, the browser 126 reads an HTML tag identifying an image file. The HTML tag in this embodiment is: <IMG SRC=“TABS.gif#img2” width=“20” height=“20”>, where the first part of the source attribute, “TABS.gif,” identifies the multi-image file 130 called “TABS.gif;” the second part of the source attribute, “#img2,” references a specific image in that multi-image file 130, and third part width=“20” height=“20”> again specifies the image's size. That is, the “#img2” attribute specifies which of the images 202-206 the web page developer wishes to have displayed initially in the browser 126. In this embodiment, “#img2” indicates that the browser should display the secondary image 204 in multi-image file 200.

At block 520, the browser 126 determines whether or not the image file is a multi-image file 200 or a conventional image file 129. If the image file is a conventional image file 129, displays the images using conventional techniques at block 530. If, however, the image file is a multi-image file 200, the browser 126 then determines at block 540 whether or not the multi-image file 200 actually contains the “img2” image 204. If the multi-file 130 correctly contains an “img2” image 204 the browser 126 displays the “img2” image 204 at block 550. If the multi-image file 130 does not contain an “img” image 204, the browser 126 defaults at block 560 to displaying the primary image 202. In some embodiments, the browser 126 may also display an error message at block 560.

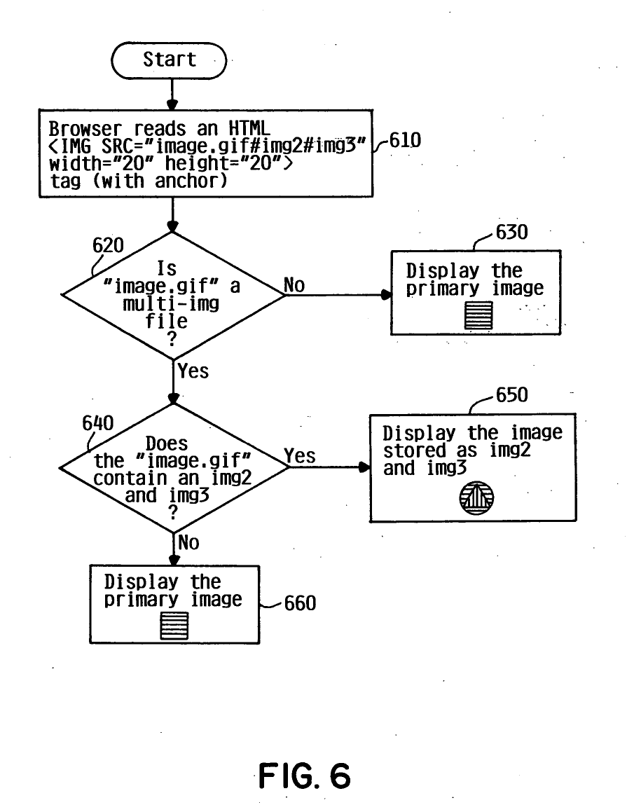

FIG. 6 illustrates one method of processing a multi-image file 200 named “TABS.gif,” which contains a primary image 202 named “img1,” a first secondary image 204 named “img2,” and a second secondary image 206 named “img3.” At block 610, the browser 126 reads an HTML tag identifying an image file. The HTML tag in this embodiment is: <IMG SRC=“TABS.gif#img2#img3” width=“20” height=“20”>, where the first part of the source attribute, “TABS.gif,” identifies the multi-image file 200 called “TABS.gif;” the second part of the source attribute, “#img2#img3”, references specific images 204, 206 in the multi-image file 200, and third part width=“20” height=“20” specifies the image's size. The browser 126 then determines at block 620 whether the image file is a multi-image file 200. If the image file is conventional, the browser 126 displays the image 129 using conventional techniques at block 630; otherwise, the browser 126 determines whether the multi-image file 200 contains an “img2” image 204 and an “img3” image 206. If both images 204, 206 are present, the browser 126 displays the images 204, 206 in a cooperative manner (i.e., in this example, “img3” would overlay “img2”). If one or both of the images 204, 206 are missing, the browser 126 displays the default, primary image 202 and optionally displays an error indication.

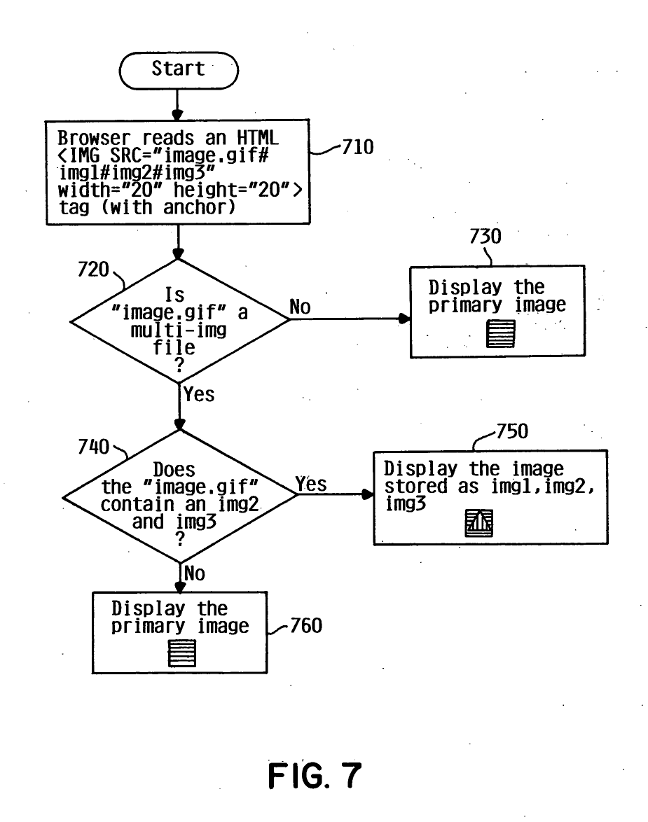

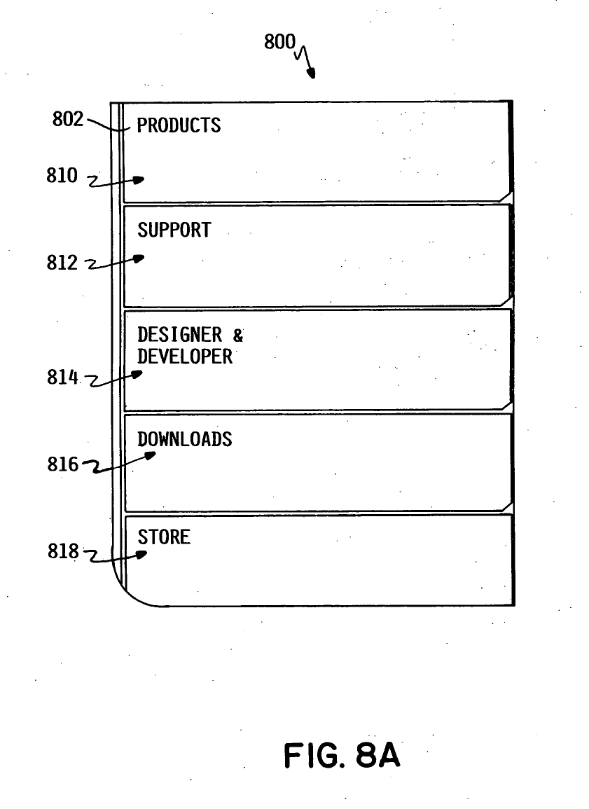

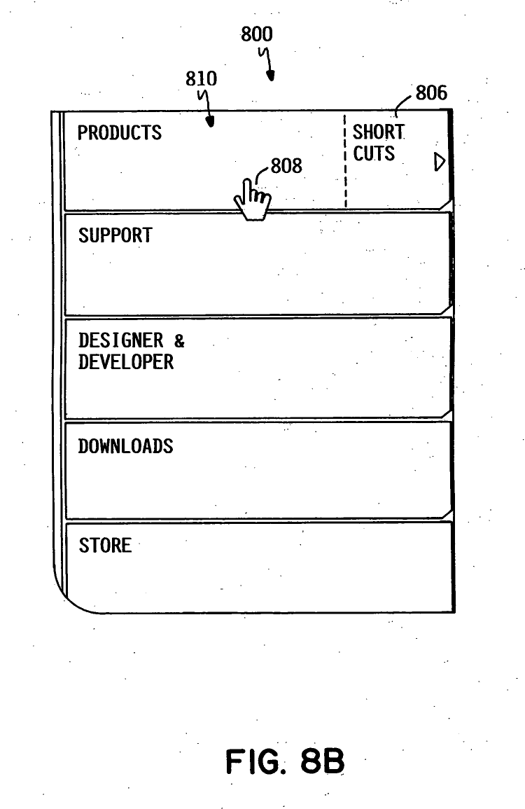

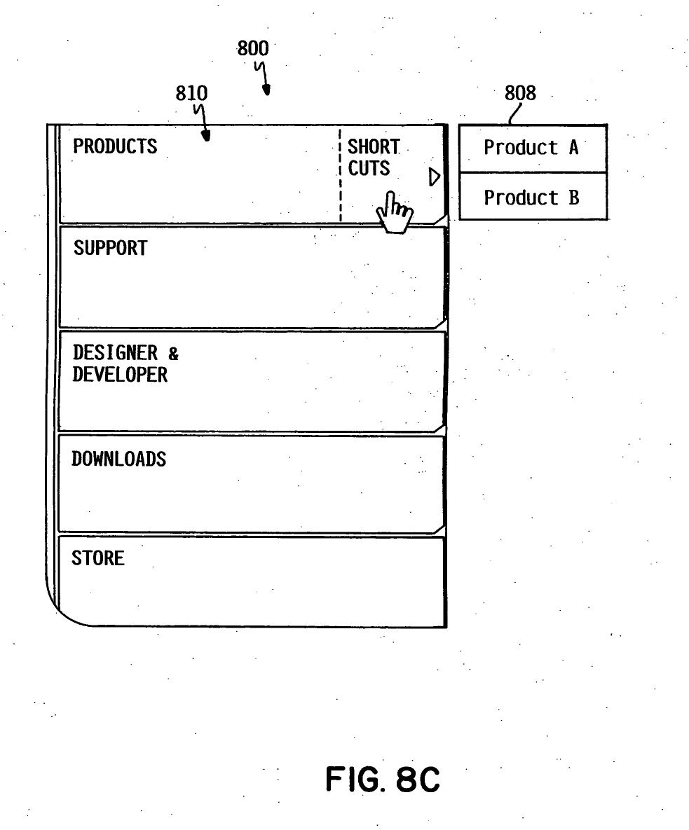

FIG. 7 illustrates another method of processing a multi-image file 200 named “TABS.gif,” which contains a primary image 202 named “img1,” a first secondary image 204 named “img2,” and a second secondary image 206 named “img3.” At block 710, the browser 126 reads an HTML tag identifying an image file. The HTML tag in this embodiment is: <IMG SRC=“TABS.gif#img1#img2#img3” width=“20” height=“20”>, where the first part of the source attribute, “TABS.gif,” identifies the multi-image file 130 called “TABS.gif;” the second part of the source attribute, “#img1#img2#img3”, references specific images 202, 204, 206 in the multi-image file 130, and third part width=“20” height=“20” specifies the images' size. The browser 126 then determines at block 720 whether the image file is a multi-image file 200. If the image file is conventional, the browser 126 displays the image 129 using conventional techniques at block 630, otherwise, the browser 126 determines whether the multi-image file 130 contains a secondary image 204 called “img2” and a secondary image 206 called “img3.” If both secondary images 204, 206 are present, the browser 126 cooperatively displays the secondary images 204, 206 together with the primary image 202 at block 750 (i.e., in this example, “img3” overlays “img2,” which overlays “img1”). If one or both of the secondary images 204, 206 are missing, the browser 126 only displays the primary image 202 and optionally displays an error indication (not shown).

Referring again to FIG. 1, the storage systems 140, 142 can be any devices capable of reading and writing digital information. The computer systems 102 in this embodiment may utilize well-known virtual addressing mechanisms that allow the programs of the computer systems 102 to behave as if they only have access to a large, single storage entity instead of access to multiple, smaller storage entities such as main memory 112 and DASD device 140. Therefore, while the operating systems 124, the web browser 126, and the web server 127 are shown to reside in main memory 112, those skilled in the art will recognize that these items are not necessarily all completely contained in main memory 112 at the same time, and may even reside in the virtual memory of other computer systems coupled to the computer system 102.

The central processing units 110 may be any device capable of executing the program instructions stored in main memory 112, and may be constructed from one or more microprocessors and/or integrated circuits. In this embodiment, when one of the computer systems 102 start up, the associated CPU 110 initially executes the program instructions that make up the operating system 124, which manages the physical and logical resources of the computer system 102. These resources include the central processing unit 110, the main memory 112, the mass storage interface 114, the display interface 116, the network interface 116, and the system bus 122. Moreover, although each computer system 102 in FIG. 1 is shown to with only a single processing unit 110 and a single system bus 122, those skilled in the art will appreciate that the present invention may be practiced using a computer system 102 that has multiple processing units 110 and/or multiple system buses 122. In addition, the interfaces 114, 116, 118, and 120 may each include their own separate, fully programmed microprocessors, which may be used to off-load compute-intensive processing from the main processing units 110.

The display interface 180 is used to directly connect one or more display units 180 to the computer system 102. These display units 180 may be non-intelligent (i.e., dumb) terminals, such as a cathode ray tube, or may themselves be fully programmable workstations used to allow IT administrators and users to communicate with one or more of the computer systems 102. Note, however, that while the display interface 116 is provided to support communication with one or more displays 180, the computer systems 102 does not necessarily require a display 180 because all needed interaction with users and other processes may occur via network interface 118.

The communication medium 106 can be any device or system that allows the computer systems 102 to communicate with each other. The network interfaces 118, accordingly, can be any device that facilitates such communication, regardless of whether the network connection is made using present-day analog and/or digital techniques or via some networking mechanism of the future. Suitable communication mediums 106 include, but are not limited to, the Internet, intranets, cellular transmission networks, wireless networks using one of the IEEE 802.11 specifications, and the like. Those skilled in the art will appreciate that many different network protocols can be used to implement the communication medium 106. The Transmission Control Protocol/Internet Protocol (“TCP/IP”) is an example of a suitable network protocol for Internet-based communication.

The embodiment described with reference to FIGS. 1-7 generally uses a client-server network architecture. These embodiments are desirable because the client computers 102b can utilize the services of the web server computers 102a without either computer system 102 requiring knowledge of the working details about the other. However, those skilled in the art will appreciate that other network architectures are within the scope of the present invention. Examples of other suitable network architectures include peer-to-peer architectures, grid architectures, and multi-tier architectures. Accordingly, the terms web server and client computer should not be construed to limit the invention to client-server network architectures.

One suitable web server 102a is an eServer iSeries computer running the OS/400 multitasking operating system, both of which are produced by International Business Machines Corporation of Armonk, N.Y. One client computer 102b is IBM Thinkpad computer running the Linux or Windows operating systems. However, those skilled in the art will appreciate that the mechanisms and apparatus of the present invention apply equally to any computer system 102 and operating system 124, regardless of whether the computer system 102 is a complicated multi-user computing apparatus, a single workstation, mobile telephone, personal digital assistant (“PDA”), video game system, or the like.

Although the present invention has generally been described with reference to a full-featured web browser 126 and a web page 128, those skilled in the art will recognize the present invention is not limited to web pages and that the browser 126 may include any device or computer program capable of rendering multi-image files 130 for display. Suitable browsers 126 include, without limitation, full-featured web browsers, such as the Netscape Navigator and Microsoft Internet Explorer browsers; thin-browsers designed to work on a telephone or personal digital assistant, such as the Pocket Internet Explorer and PalmScape browsers; helper applications designed to work with browsers (e.g., “plug-ins,” such as Adobe Acrobat and Macromedia Flash, and Java applets); and graphical operating systems and application programs that store graphical user interface elements or other graphical images for display, and the like.

The present invention may be also embodied in other specific forms without departing from the essential spirit or attributes thereof. For example, those skilled in the art will appreciate that the present invention is capable of being distributed as a program product in a variety of forms, and applies equally regardless of the particular type of signal bearing media used to actually carry out the distribution. Examples of suitable signal bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive, a CD-R disk, a CD-RW disk, or hard-disk drive); or (iii) information conveyed to a computer by a communications medium, such as through a computer or telephone network, including wireless communications, and specifically includes information downloaded from the Internet and other networks. Such signal-bearing media, when carrying computer-readable instructions that direct the functions of the present invention, represent embodiments of the present invention. Some embodiments of the present invention may also allow for special effect transitions between images in the multi-image file.

The present invention and its multi-image files 130 offer numerous advantages over conventional image delivery formats. For example, those skilled in the art will appreciate that the present invention and its multi-images files 130 allow many graphical elements to be stored in a single file, which reduces the number of server connections needed to download a graphically rich site and increases apparent speed. Another advantage of the present invention is that web page developers can use scripting languages, such as JavaScript, to create animations and overlay multiple images from a single multi-image file 130 more easily and more robustly than possible using conventional animated-GIF techniques because the multi-image files 130 of the present invention eliminate overhead associated with preloading and referencing multiple images. For example, a photo-editing program could automatically save its named layers into an image as the primary 202 and secondary images 204-206, thereby avoiding the time consuming and error prone task of saving each layer into a separate GIF file. The layer names in the photo editing program could even be used to determine the names of images in the multi-image file 130.

Another advantage of the present invention and its multi-image files 130 is that the creator of a multi-image file 301 can specify any of the images in the multi-image file 130 as the primary image. If the creator does not specify which image should be displayed, the browser 126 will default to the first image in the sequence. This feature and advantage enables the multi-image file 130 to be backwards-compatible with older browsers and provides web designers with more flexibility when using layers to create images. This feature and advantage also allows the designated primary image to be loaded by default, while using JavaScript or the like to reference the secondary images for easier and more flexible animation.

Another feature and advantage of the present invention is that web designers can save a group of individual images into a multi-image file 130 by first “marquis-selecting” areas of an image and then saving each portion as a primary or secondary image, or by using the “slices” feature of photo-editing programs. The browser 126 could then select and display the correct image from the multi-image file 130, or the server 102a could parse the correct image out of the multi-image files and “stream” the only the necessary image(s) as needed. This feature may be particularly desirable for web designers tying to ensure that frequently copied images contain the correct alternate designation in order to satisfy universal access rules, and to content providers trying to implement a digital rights management infrastructure.

Yet another feature and advantage is that the multi-image files 130 can contain different size and shaped images. This allows the web page designer to identify and segregate those portions that contain dynamic elements from those portions that are static. This feature may be particularly desirable on devices with limited processing power and/or storage. Other advantages include: (i) pages with multiple images that are pieced together as one large image would all load at once, thereby eliminating the need to watch the web page assemble image by image; and (ii) multi-image files 130 could contain multiple language versions of the same image, making it easier to swap images out based on the viewers' language. Other features and advantages of the present invention include that the multi-image files 130 and its image descriptors can allow for the use of different sizes and color palettes, and that the HTML codes used in some embodiments is identical to the attributes currently for referencing a specific portion of a web page.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Therefore, it is desired that the embodiments described herein be considered in all respects as illustrative, not restrictive, and that reference be made to the appended claims for determining the scope of the invention.

1. A method of displaying a web page, comprising:
receiving a multi-image file, the multi-image file comprising a primary image and at least one secondary image adapted for cooperative display;
receiving a web page containing a markup language tag, the markup language tag comprising a code specifying which of the primary image and the secondary image should be displayed; and
displaying the web page with the primary image.

2. The method of claim 1, further comprising:
parsing the multi-image file for an information header, the information header containing an image name for each image in the multi-image file.

3. The method of clam 2, wherein the information header further comprises a primary image indicator.

4. The method of claim 2, wherein the information header further comprises an image location for each image in the multi-image file.

5. The method of claim 1, further comprising:
in response to an event, displaying the web page with the secondary image.

6. The method of claim 5, wherein the event comprises a mouse-over event.

7. The method of claim 1, wherein the multi-image file comprises a menu element.

8. The method of claim 1, wherein the markup language tag comprises an HTML code.

9. A web page, comprising:
a multi-image file, the multi-image file comprising a primary image and at least one secondary image adapted for cooperative display; and
a markup language tag, the markup language tag comprising a code specified which of the primary image and the secondary image should be displayed.

10. The web page of claim 9, wherein the multi-image file further comprises an image descriptor associated with the primary image and an image descriptor associated with the at least one secondary image.

11. The web page of claim 10, wherein the image descriptor comprises an image name, a primary image indicator, and a default size.

12. The web page of claim 9, wherein the multi-image file further comprises an information header containing at least one image descriptor.

13. A method of displaying images, comprising:
receiving a multi-image file, the multi-image file comprising a primary image and at least one secondary image;
selecting an image for display from the multi-image file; and
displaying the selected image.

14. The method of claim 13, wherein the multi-image file further comprises a first image descriptor associated with the primary image and a second image descriptor associated with the secondary image.

15. The method of claim 13, wherein the first image descriptor comprises a primary image indicator.

16. A computer program product, comprising:
(a) a program configured to perform a method for rendering images in a computer system, the method comprising:
receiving a multi-image file, the multi-image file comprising a primary image and at least one secondary image;
selecting an image for display from the multi-image file; and
displaying the selected image; and
(b) a signal bearing media bearing the program.

17. The computer program product of claim 16, wherein the program comprises a web browser.

18. The computer program product of claim 16, wherein the signal bearing media is chosen from the group consisting of information permanently stored on non-writable storage media; alterable information stored on writable storage media; and information conveyed to a computer by a communications medium.

19. The computer program product of claim 16, wherein the primary image and the at least one secondary image comprise complementary layers.

20. The computer program product of claim 16, wherein the primary image and the at least one secondary image comprise alternative versions of an image.

21. The computer program product of claim 16, wherein the at least one secondary image overlays the primary image.
